(19) United States
(12) Patent Application Publication
(10) Pub. No.: US 2016/0351076 A1
(43) Pub. Date: Dec. 1, 2016

(54) DEVICES AND METHODS FOR HANDS-ON TEACHING AND LEARNING OF MATHEMATICAL CONCEPTS

(71) Applicant: MIND Research Institute, Irvine, CA (US)

(72) Inventors: Matthew R. Peterson, Irvine, CA (US); Brandon Smith, Irvine, CA (US)

(73) Assignee: MIND Research Institute, Irvine, CA (US)

(21) Appl. No.: 15/164,510

(22) Filed: May 25, 2016

Related U.S. Application Data
(60) Provisional application No. 62/166,331, filed on May 26, 2015.

(51) Int. Cl. G09B 23/02; G09B 19/02

(52) U.S. Cl. CPC G09B 23/02; G09B 19/02

(57) ABSTRACT

Devices and methods for teaching and learning mathematical concepts are provided as a mathematics manipulative having a base with a plurality of receptacles, each configured for accepting one of a plurality of blocks in an orientation such that faces of the block are angled with respect to a horizontal bottom surface of the base. Each of the blocks has a plurality of faces, each face having an indication of a value; wherein the plurality of receptacles are sized and arranged such that, when blocks are placed in the receptacles, adjacent blocks define a space configured for accepting another block; and wherein the values indicated on the faces of each of the blocks are combinable with the values indicated on the faces of the other blocks in accordance with a mathematical operation. Games played in accordance with a method of using the mathematics manipulative blocks teach mathematics concepts.

### CROSS-REFERENCE TO RELATED APPLICATIONS

This Application claims the benefit, under 35 U.S.C. §119(e), of U.S. Provisional Application No. 62/166,331; filed May 26, 2015, the disclosure of which is incorporated herein by reference in its entirety.

### BACKGROUND

This disclosure is related to physical teaching models and in particular, to physical models for teaching mathematical concepts.

Principles of mathematics maybe challenging to visualize and comprehend for students. Many students (or users, used interchangeably throughout this specification) often have difficulty learning arithmetic calculations rapidly and abstractly. Visual and manipulative aids can be useful in providing context for various mathematics concepts. Additionally, learning is often more engaging and lessons more memorable when a student is able to learn concepts in the context of a game. Continuous efforts are being made to improve teaching techniques and devices to aid students.

### SUMMARY

Broadly, in one aspect, the present disclosure relates to a device for teaching mathematical concepts, comprising: a plurality of blocks, each block having a plurality of faces, each face having indicia indicating a value; and a base having a plurality of receptacles, each of the receptacles being configured for accepting one of the plurality of blocks in an orientation such that the faces of the blocks are angled with respect to horizontal; wherein the plurality of receptacles are sized and arranged such that, when the blocks are placed in the receptacles, adjacent blocks form a space configured for accepting another block; and wherein the values indicated by the indicia on the faces of each of the blocks are combinable with the values indicated by the indicia on the faces of the other blocks in accordance with a mathematical operation.

In another aspect, this disclosure relates to a method for teaching and learning mathematical concepts, comprising: (a) stacking a plurality of blocks on a base having a base value, wherein the base comprises a plurality of receptacles, each of which is configured to accept a block in an orientation in which a vertex of the block is seated in the receptacle, such that the blocks are stacked in successive layers of blocks to form a trigonal pyramid, each of the blocks occupying a space in one of the layers, each of the blocks having a plurality of faces, each of the faces including indicia indicating a mathematical value; (b) taking a plurality of turns among one or more players, a turn for a player comprising: (i) removing a first block from the stack, the removed first block having, before removal, at least two exposed faces and at least a second block above it in the stack, the removal of the first block allowing the second block to move into a space formerly occupied by the removed first block; (ii) determining first and second scoring values, the first scoring value being determined from a value indicated by the indicia on one face of the second block, and the second scoring value being determined by either the base value or a value indicated on a face of a third block, whichever the second block rests upon when it has moved into the space formerly occupied by the first block; (iii) selecting a mathematical operation to use with the first and second scoring values; and (iv) determining a turn score based on at least the first and second scoring values and the mathematical operation; and (c) scoring the game based on the turn scores of each player.

This brief summary has been provided so that the nature of this disclosure may be understood quickly. A more complete understanding of the disclosure can be obtained by reference to the following detailed description of the various aspects thereof in connection with the attached drawings.

### BRIEF DESCRIPTION OF THE DRAWINGS

These and other features and advantages of the present device, systems, and methods will become appreciated as the same become better understood with reference to the specification, claims and appended drawings wherein like reference numerals reflect like elements as illustrated in the following figures:

FIG. 1 is a top perspective view of a base for a mathematics manipulative, according to an aspect of the present disclosure;

FIG. 2 is a front perspective view of the mathematics manipulative of FIG. 1 including stacked blocks, in accordance with an aspect of the present disclosure;

FIG. 3A is another perspective view of the base shown in FIG. 1;

FIG. 3B is a top perspective view of the manipulative of FIG. 2;

FIG. 3C is a perspective view of two individual blocks of the manipulative of FIG. 2;

FIG. 4 is a perspective view of another mathematics manipulative in accordance with an aspect of the present disclosure;

FIG. 5 is a perspective view of another mathematics manipulative in accordance with an aspect of the present disclosure;

FIG. 6 is a perspective view of another mathematics manipulative in accordance with an aspect of the present disclosure; and

FIGS. 7A and 7B are flow charts illustrating exemplary methods for playing a game using a mathematics manipulative in accordance with an aspect of the present disclosure.

### DETAILED DESCRIPTION

The use of physical devices that can be manipulated (manipulatives) for teaching mathematical concepts relies on a constructivist educational paradigm, which can build upon a student's physical intuitions and broaden understanding of more abstract ideas. As such, a device for teaching mathematics concepts is provided according to an aspect of the disclosure. In an aspect, the mathematics-teaching device can be used to play a game which provides a fun, interactive method for learning and practicing mathematics concepts such as arithmetic.

In one aspect, teaching aids for teaching mathematics concepts, such as arithmetic, are disclosed herein. Providing a physical model that can be manipulated by a teacher or student can help a student engage in the learning process. This may be particularly true when the concepts can be taught in the context of a game that is fun and enjoyable for the student players.

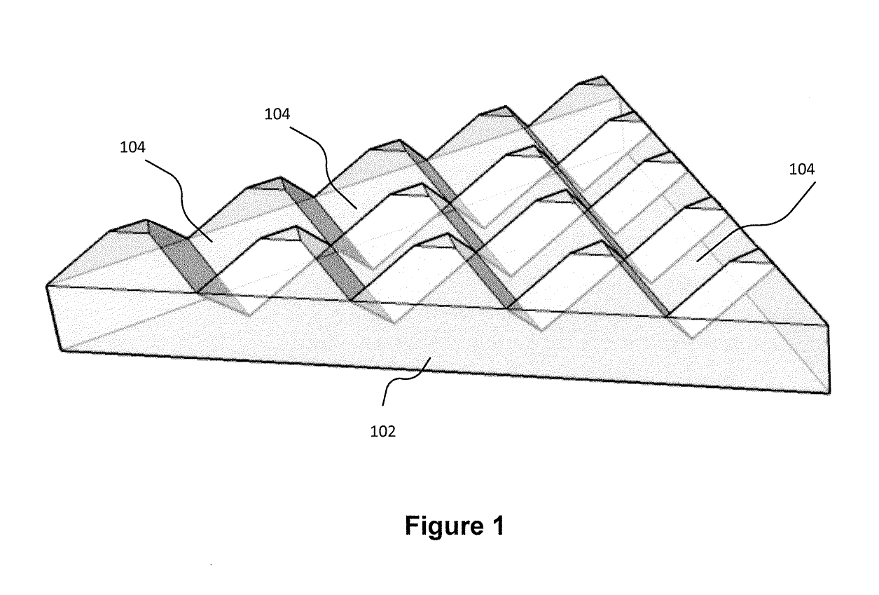

FIGS. 1, 2, and 3A-C illustrate an embodiment of a manipulative 100, comprising a polygonal base 102 having a bottom surface defining a horizontal plane. The upper surface of the base 102 is configured to receive and hold a set of multi-sided blocks 106. In the illustrated exemplary embodiment, the base 102 is triangular in shape and includes ten receptacles (slots or depressions) 104, each of which defines a space configured to receive and hold any one of a plurality blocks 106 (preferably six-sided cubes), such that each block 106 generally rests in its associated receptacle 104 on one of its vertices and contacts adjacent blocks 106 in the base 102 along an edge.

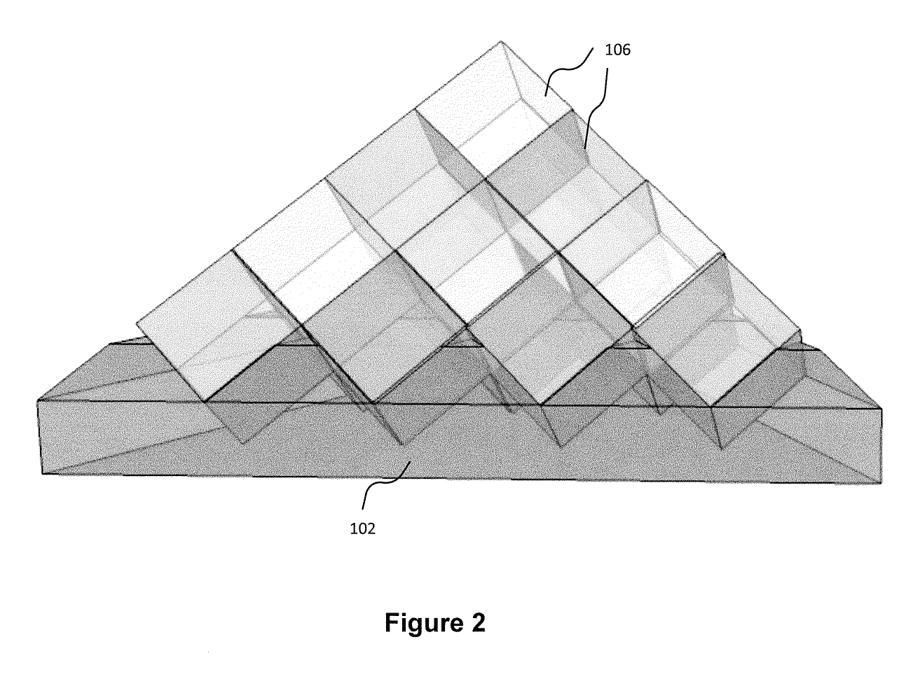

FIG. 2 illustrates an example of such a polygonal base 102 with stacked blocks 106 arranged in a succession of decreasing-sized layers to form a trigonal pyramid-like structure for the manipulative 100. As illustrated, each block 106 in a bottom layer of blocks rests within one of the receptacles or slots 104 of the base 102. Each of the other blocks is received and seated in a similarly shaped space that is formed in the layer of blocks immediately below it. In the illustrated example, there are twenty blocks 106 used to create such a trigonal pyramid. The base 102 may be configured in any of a variety of shapes and sizes, and other block shapes may be used to create other shapes and manipulatives within the scope of this disclosure. For example, similar triangular bases may include 15 or 21 slots or receptacles 104, with corresponding sets of 35 or 56 blocks, respectively, to complete the trigonal pyramids. In some aspects, for example, the blocks 106 may be tetrahedrons, cubes, octahedrons, dodecahedrons, or icosahedrons, and the associated bases 102 may include receptacles (slots or depressions) 104 that are sized and shaped accordingly to accept the blocks 106 in orientations that allow for the building of trigonal pyramidal shapes or other shapes as may be extrapolated from the types of interactions described herein.

The base 102 may be formed of any suitable generally rigid material, such as wood, metal, plastic, rubber, or the like, and it may be generally transparent, translucent, or opaque. The base 102 may also be color-coded or otherwise marked to associate it with particular blocks 106 with which it is designed to be used, to differentiate one set comprising a base 102 and associated blocks 106 from another base/block set, or the like.

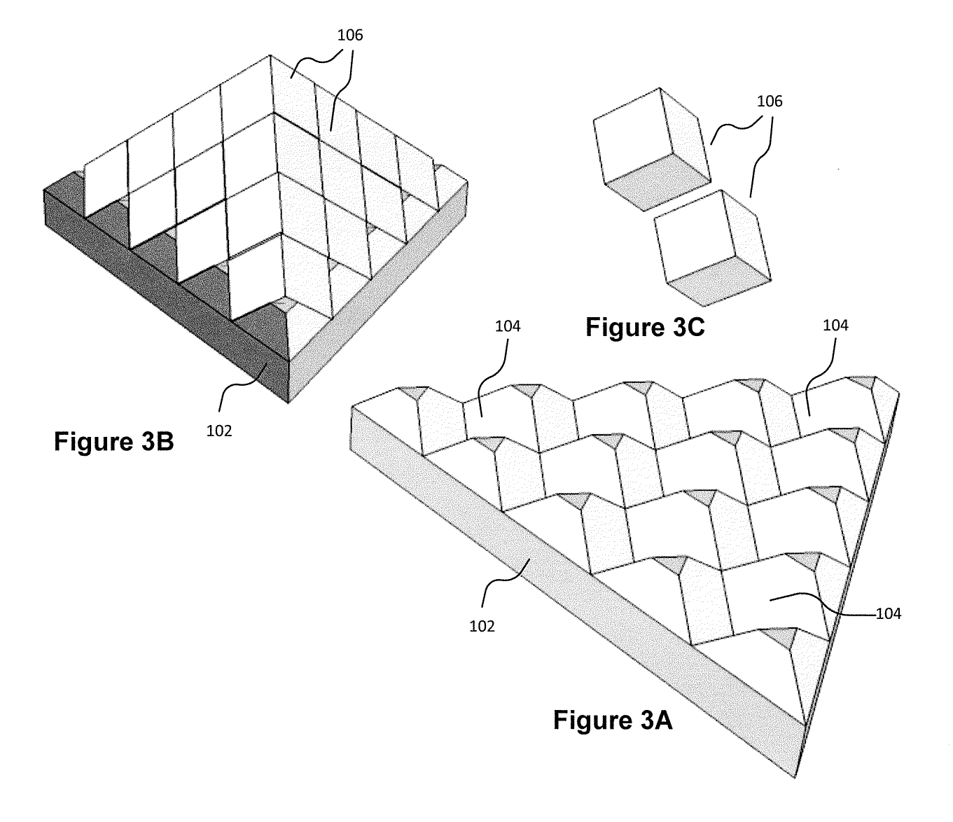

FIGS. 3A-C illustrate a mathematics manipulative 100 similar to that described with respect to FIGS. 1 and 2, as well as example components thereof. In particular, the mathematics manipulative 100 includes a base 102 and a plurality of blocks 106 (two of which are shown independently in FIG. 3C) that can be stacked on the base 102 to create a trigonal pyramid as shown.

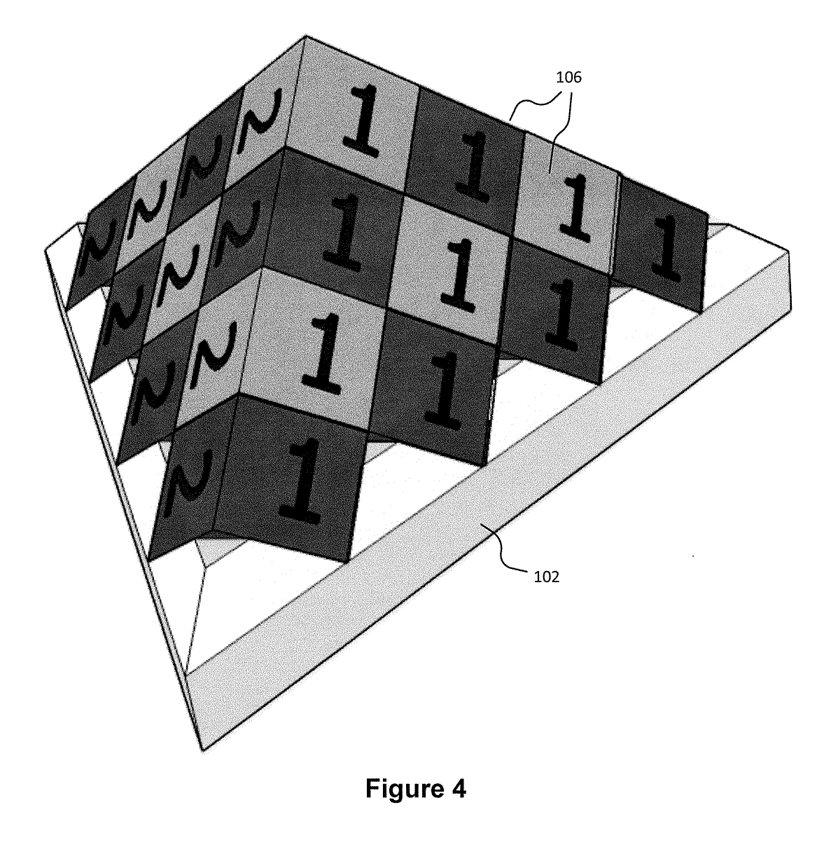

FIG. 4 illustrates another example of a mathematics manipulative 100′, comprising a base 102′ that receives a plurality of blocks 106′. The blocks 106′ are preferably in the form of cubes that (by definition) have six sides or faces. According to an aspect, each block or cube 106′ includes numbering on one or more faces of the block. The numbering that is shown on the faces can then be used in playing a game according to various aspects of the disclosure as described below. According to another aspect, the faces of the blocks 106′ may be provided with symbols, images, or indicia of numbers or expressions that facilitate arithmetic operations when a student or game-player combines the symbols or indicia on different blocks with one or more specific operators or an operator of the student's choice.

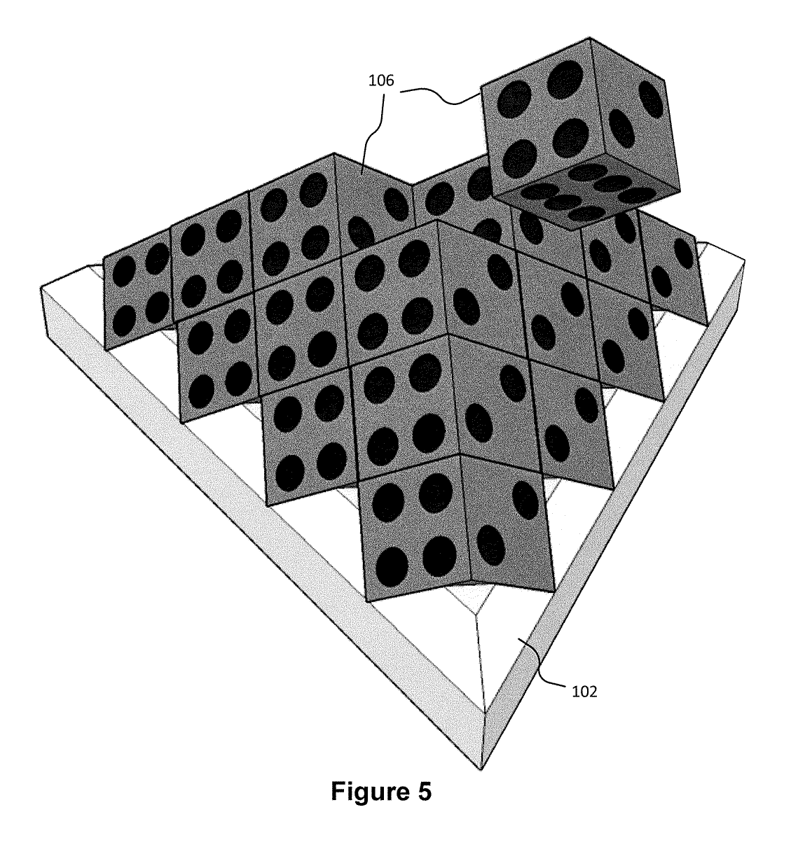

FIG. 5 illustrates another example of a mathematics manipulative 100″ in which the blocks 106″ may comprise standard dice or otherwise resemble dice in their shape and/or numbering. In an aspect, it may be preferable for the blocks 106″ to have commonly arranged values (for example, opposite faces of a standard die that add up to seven); however, more random arrangements or values may provide an element of randomness and luck to a game played with the mathematics manipulative in other aspects.

The math manipulative may be used for individual practice or challenge, or it may be used as a game with scoring options. In general, blocks are removed (one or more at a time) in a manner that allows blocks stacked above a removed block to move down (e.g., by gravity) into the space previously occupied by the removed block without destroying the basic stacked block structure. At each move, blocks (or block faces) with different values will come into contact and can be mathematically manipulated to provide a manner of scoring the move. As blocks are removed, the stack will diminish until no more blocks can be removed based on a set of rules, some of which will be described below.

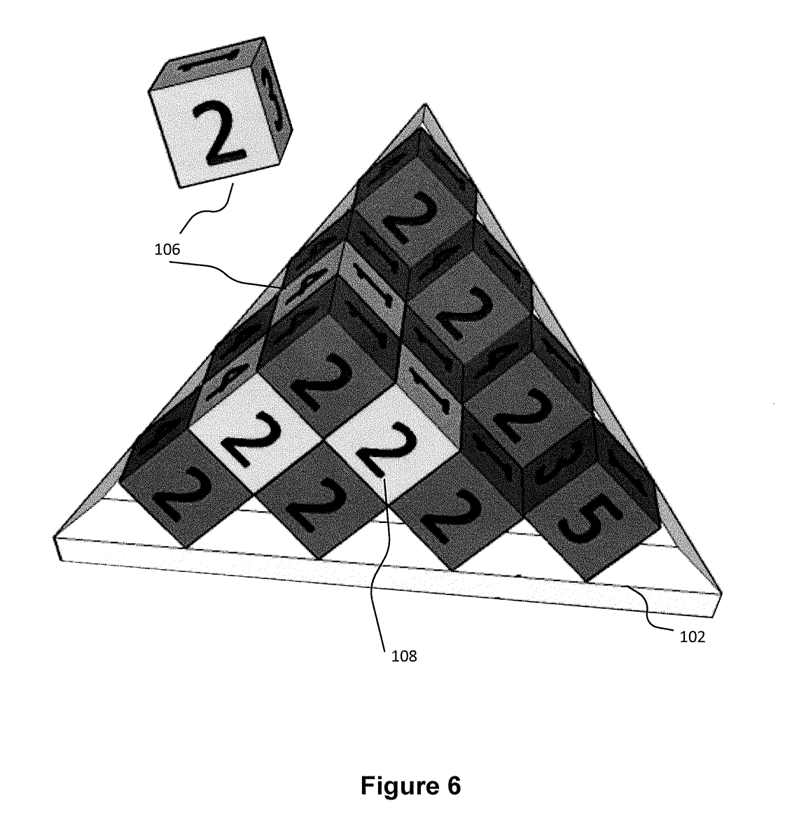

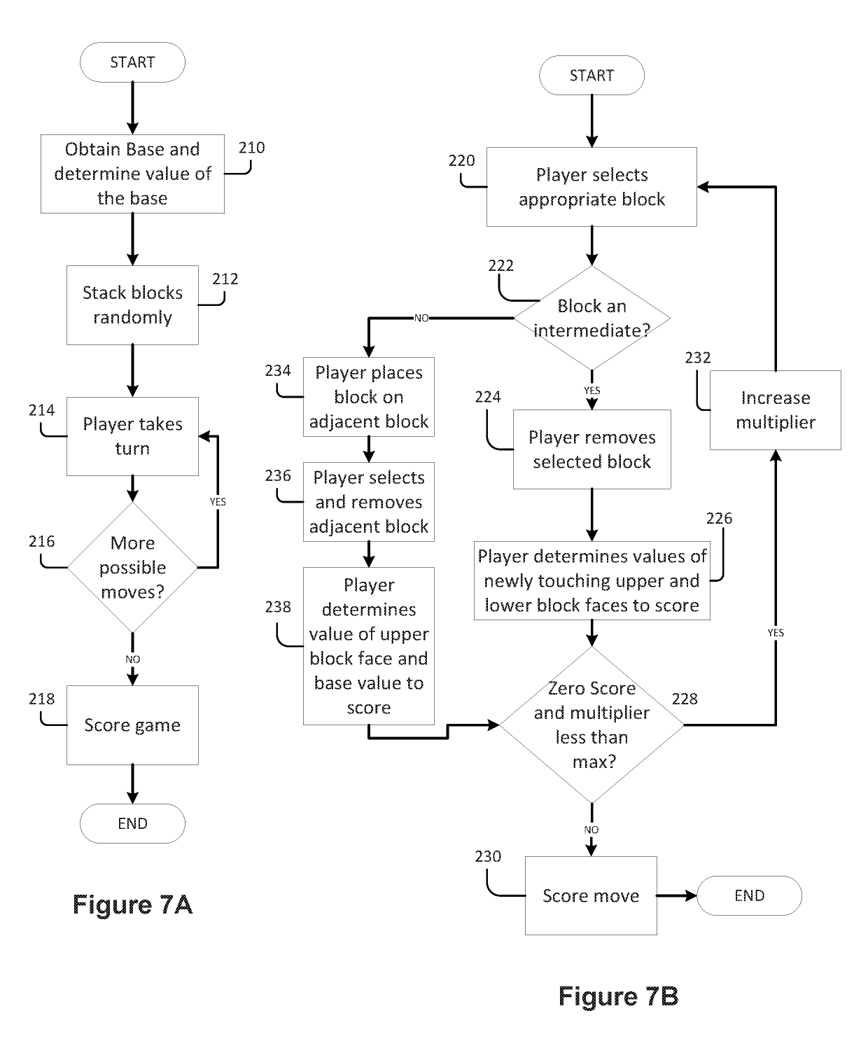

A variety of games using the manipulatives of the present disclosure may be played by two or more players. Typically, but not exclusively, such games may be played in a succession of rounds in which each player may take one or more turns. Because the cube designs vary and the arrangements and combinations of the cubes are flexible, many arithmetic results are possible in each round of the game. The object of the mathematical practice or game is to obtain the highest score based on following logical and strategic rule sets, and variations on those rule sets. FIG. 7A illustrates an exemplary method for interacting with a mathematics manipulative through playing a game with one or more players according to an aspect. FIG. 7B illustrates a related aspect of a method for taking a turn in an aspect of playing the game and interacting with a mathematics manipulative. The methods illustrated in FIGS. 7A and 7B will be described in conjunction with the exemplary manipulative embodiment 100 shown in FIG. 6, comprising a base 102 and a plurality of blocks 106. In this exemplary embodiment, each of the six sides or faces of each block 106 includes a unique value indicated by a numeral from 1 to 6.

Starting with FIG. 7A, the game or practice starts at step 210 by determining a value for a base, such as the base 102 illustrated in FIG. 6. Determining the value of the base may be accomplished through a variety of ways. In one example, one of the blocks 106 (FIG. 6) is rolled, and the value of the face that ends up on top may be the value of the base 102 for the game. In other examples, the base 102 may have a set value based on the number of players, a randomly chosen value, or the like. In still another example, the base 102 may include one or more values for each receptacle 104 marked on them in an appropriate manner (such as decals, paint, etchings, or being formed as part of the base—such as through molding).

At step 212, at least one of the players selects and stacks the blocks 106 on the base 102. Preferably this is done at random without regard to block orientation. In general, each base receptacle or slot 104 will define a space configured to accept one block 106 in one of several orientations, and each completed layer of blocks 106 will define more spaces in which to stack additional layers of blocks 106. In the case of the base 102 and blocks 106 illustrated in, for example, FIG. 6, the blocks 106 are stacked in successive layers, decreasing in size from bottom to top, to form a trigonal pyramid. With other base shapes or block shapes, other starting geometric forms may be used.

At step 214, a player takes his or her turn, which is described in more detail with respect to FIG. 7B. Once that player's turn is completed, it is determined whether or not there are additional legal or permitted moves at step 216. If so, the next player takes his or her turn at step 214. Play continues in this manner, and, preferably, each player takes one turn before any player is allowed to take another. When there are no more moves available, the game is scored at step 218 to determine the winner, and the game ends. Alternatively, this could be considered a round, and the process of FIG. 7A can be restarted with scores kept across rounds to create a longer game.

In general, each turn of the game includes a player performing an arithmetic operation on two blocks in the geometric form by extracting or removing one block that separates them. In an aspect, to be a legal or permitted move, the extracted or removed block has at least two faces exposed. Once removed, a first block above the extracted block will move (e.g., by gravity) into the space formerly occupied by the extracted or removed block and into contact with a second block directly beneath it. The player then lifts the first block and views the value on the faces of the first and second blocks that are facing each other (in contact when the blocks are at rest). The player performs an arithmetic operation with the values represented by numerals or symbols on the faces of these two adjacent blocks by choosing a mathematical operation from a set of legal operations for that game (for example, addition, subtraction, multiplication or division). The object is to select an operation that yields the highest score. However, in an aspect, selecting an operation that yields a zero result allows each player to take another turn with an increased score multiple, such that his or her next score earns two times the points, for example.

More specifically, FIG. 7B illustrates a player's turn according to an aspect of a disclosed game. Starting at step 220, the player selects an appropriate block 106 for extraction. In an aspect, in order to be an allowed selection, the block must have at least two faces showing. In a further aspect, the block must also have at least one block resting above it unless all remaining blocks are at the lowest (base) level of blocks (those sitting in base receptacles 104); however, in other aspects, this may not be required.

At step 222, it is determined whether or not the selected block is an intermediate block (i.e., it has a block resting on top of it). Block 108 of FIG. 6 illustrates an example of an acceptable intermediate block.

When it is an intermediate block, the player simply removes the selected block 106 at step 224, which allows the block above it to move down into the extracted block's former space or position. Other higher blocks may shift position as well.

At step 226, the player determines the values of the faces of the blocks 106 that are newly touching (that is the faces that had been adjacent to the extracted block). This likely will be accomplished through lifting the blocks apart and then replacing the upper block in the same orientation. In another aspect, when a base level block is both an appropriate block for extraction and an intermediate block, the player determines the value of the face from the upper block that was formerly touching the extracted block and is now resting on the base and the value of the base (as determined in FIG. 7A at step 210—or as otherwise determined as discussed herein). These two values are used to calculate a possible score, based on a player-selected operation from among a set of acceptable mathematical operations, with the object generally to achieve the highest score. However, getting two blocks that can equal a zero score is a special case as described below. An exemplary set of values and possible choices is set forth in the following table, but various rules or rule alternatives may change possible selections in various aspects of the games described. These examples are in no way limiting, nor are they the only choices that may be made even based on the rules upon which the table was created:

| | | Operator | |
|---|---|---|---|
| Face Value 1 | Face Value 2 | (+, −, ×, or /) | Score |
| 2 | 5 | × | 10 |
| 1 | 4 | + | 5 |
| 3 | 3 | − | 0 |
| 5 | 5 | × | 25 |

It can be seen from the examples above that multiplication (if available as an operator) is likely to yield the highest score, but addition may be preferable in some circumstances. If a player is able to choose an operator that allows a zero (subtraction is the only possible operator in the above table), a “bonus” turn is triggered, whereby the player may receive another turn or chance (in the same round or a successive round) to make an extraction with a multiplier applied to the resultant score.

Step 228 illustrates the situation in which it is determined whether or not there is a zero score and if the multiplier is less than a maximum. For example, the first time a player makes an extraction during a turn, the multiplier may be one, and a maximum multiplier may be three. When the player is able to make a zero score and the current multiplier is less than a maximum, play continues to step 232 in which the multiplier is increased (for example from one to two or from two to three) and then returns to step 220, where the player is allowed to select another appropriate block for extraction.

If the player does not have a zero score, or if he or she has already reached the maximum multiplier, the player continues to step 230, where the final score for the turn is determined based on the player-selected operator and any multiplier.

Because the number of blocks 106 continues to decrease throughout the game, there will come a point when there are no intermediate blocks that can be selected. In such a situation, the player must select a block from the base level. In some other aspects, a player may be able to select a base level block even when intermediate blocks are available. In this situation, the player's selection is not an intermediate block in step 222, and the player proceeds to step 234. At step 234, the player picks up the selected block and places it on top of an adjacent block, thereby making one or more intermediate blocks. At step 236, the player then selects and removes the adjacent block, which is now an intermediate block. The originally-selected block will then move back into contact with the base, and the player will determine the values of the base and of the originally selected block's face that had been touching the extracted block in order to determine a score at step 238. Continuing then to step 228, the player determines if there is a zero score and the multiplier is less than a maximum, as described above. If not, the final score is determined in block 230, and the player's turn ends.

While the basic play and interaction with the mathematics manipulative has been shown and described herein, it will be appreciated that many alternatives to the basic rules set out herein are possible without detracting from the contemplated invention. For example, the maximum multiplier may be raised or lowered. Additionally the multiplier may change linearly or non-linearly (such as exponentially) and may be further used to enhance a player's learning and practice of mathematics. In other aspects, different mathematics operations may be allowed. For example, only addition and subtraction may be allowed in one game; in another, only multiplication and division may be allowed; in still another, only one operation may be allowed. In some games, the “zero score” that allows an additional block selection and increased multiplier may be a minimum possible value or another special value, such as, for example, trying to achieve a value of 1 when only multiplication and division are acceptable operators (and thus zero may not be achievable). Block face values can have various ranges in different aspects as well. In some aspects, the blocks may be dice with standard values one through six; in other aspects, values may include positive or negative integers, fractions, or the like in order to emphasize learning different mathematics skills.

It should also be understood that the term “step” used herein does not imply a necessitated order, as FIGS. 7A and 7B are examples only. Certain steps described herein may be accomplished in different orders without detracting from the spirit of the disclosure herein. For example, a player may determine scoring face values while extracting a block, scores may be determined at different times or simultaneously with other steps, running scores may be tallied throughout the game, and “steps” may be split apart or combined and rearranged in various other ways. For example, with respect to FIG. 7A, in another aspect, a variation of the game may include that step 212 (setting up the game) may occur before step 210 (setting the value of the base). For example, a player may remove the block situated at the highest point in the stack and roll it. The exposed value on an upper face of the block may then become the numeric value of the base, and that block is restored to its original position.

One may note that game strategy may provide an incentive for a player to anticipate which faces of the blocks will be used in scoring before selecting a block for extraction. This is aided by players recognizing patterns for the symbols or indicia on the blocks (e.g., recognizing that opposite sides of a standard die add up to seven), remembering how the symbols or indicia are ordered, and using the visual cues from the exposed faces of the blocks to predict the symbols or indicia on the underside.

In another aspect, a variation on the game includes having a player remove two blocks in each turn, and using the two removed blocks in the arithmetic operation during a single player's turn. Another variation on the game is to limit the stack to a fixed number of blocks, for example, 20, so as to limit the number of rounds.

It is also contemplated that the mathematics manipulative and game described herein may be implemented in software and operated on computer hardware so that the mathematics manipulative exists in a virtual environment. Such an implementation may include a general or special purpose processor connected to memory and at least one input device and one output device and/or one combined input/output device. For example, such devices may include a display, keyboard, mouse, touch-screen display, and/or the like.

Still other variations include: eliminating a player when he or she performs the arithmetic incorrectly; having the player with the lowest total score win the game; using blocks having a geometric pattern on each of the six sides and using geometric properties in determining scoring; using external gaming elements (e.g., a timer) in conjunction with the base and blocks to add complexity or challenge. In another aspect, an external die or dice may be used to determine primary or secondary math operations, or a spinner card may be used to add restrictions or increase point value during a player's turn. In another aspect, the blocks may be stacked during setup so that the faces that all have equivalent values are visible on one or more side(s) of the stack (as shown in FIGS. 4 and 5), while in another aspect, the blocks may be stacked during setup so that the faces of the stack conform to a particular numeric pattern.

In another aspect, multiple bases may be used simultaneously, with each base having the same or different values. In such an aspect, players may take turns as described above with the same general rule set. However, when repositioning a block that is in contact with the base, it may be removed from one base and placed in any base.

Thus, methods and devices for mathematics learning have been described. Note that references throughout this specification to “one embodiment” or “an embodiment” or “one aspect” or “an aspect” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” (or similar uses of “aspect”) in various portions of this specification are not necessarily all referring to the same embodiment. Furthermore, the particular features, structures or characteristics being referred to may be combined as suitable in one or more embodiments of the disclosure, as will be recognized by those of ordinary skill in the art. Additionally, alternatives other than those specifically described herein will be understood to fall within the scope of the teachings herein. While the present disclosure is described above with respect to what is currently considered its preferred embodiments, it is to be understood that the disclosure is not limited to that described above.

What is claimed is:

1. A device for teaching mathematics, comprising:
a plurality of blocks, each block having a plurality of faces, each face having indicia indicating a value; and
a base having a horizontal bottom surface and a top surface defining a plurality of receptacles, each of the receptacles defining a space configured for accepting one of the plurality of blocks in an orientation such that the faces of the blocks are angled with respect to horizontal;
wherein the plurality of receptacles are sized and arranged such that, when the blocks are placed in the receptacles, adjacent blocks form a space configured for accepting another block; and
wherein the values indicated by the indicia on the faces of each of the blocks are combinable with the values indicated by the indicia on the faces of the other blocks in accordance with a mathematical operation.

2. The device of claim 1 wherein each of the plurality of blocks is a cube.

3. The device of claim 2 wherein the plurality of receptacles are arranged in a triangular pattern.

4. The device of claim 3 wherein the plurality of blocks comprises a succession of layers of blocks stacked on the base in the configuration of a trigonal pyramid.

5. The device of claim 4, wherein the succession of layers comprises:
a base layer of blocks, wherein each of the blocks in the base layer is received in one of the receptacles of the base; and
at least one upper layer of blocks stacked on the base layer, wherein each of the blocks in each upper layer is received in a space created by the blocks of the layer immediately below the at least one upper layer.

6. The device of claim 4, wherein the removal of any one block having two exposed faces from the stack allows an adjacent block from a successive layer to move into the space formerly occupied by the removed block.

7. The device of claim 2 wherein each of the plurality of receptacles is configured to accept a block such that a vertex of the block is seated in the receptacle.

8. A method for learning mathematics concepts, comprising:
(a) stacking a plurality of blocks on a base having a base value, wherein the base comprises a plurality of receptacles, each of the receptacles defining a space configured to accept a block in an orientation in which a vertex of the block is seated in the receptacle, such that the blocks are stacked in successive layers of blocks to form a trigonal pyramid, each block occupying a space in one of the layers, each block having a plurality of faces, each of the faces including indicia indicating a mathematical value;
(b) taking a plurality of turns among one or more players, a turn for a player comprising:
(i) removing a first block from the stack, the removed first block having, before removal, at least two exposed faces and at least a second block above it in the stack, the removal of the first block allowing the second block to move into a space formerly occupied by the removed first block;
(ii) determining first and second scoring values, the first scoring value being determined from a value indicated by the indicia on one face of the second block, and the second scoring value being determined by either the base value or a value indicated on a face of a third block, whichever the second block rests upon after it has moved;
(iii) selecting a mathematical operation to use with the first and second scoring values; and
(iv) determining a turn score based on at least the first and second scoring values and the mathematical operation; and
(c) scoring the game based on the turn scores of each player.

9. The method of claim 8, wherein the plurality of turns is a predetermined number of turns, and wherein scoring the game occurs when the predetermined number of turns has been reached.

10. The method of claim 8, wherein the turn further comprises:
(v) determining whether the turn score can equal zero;
(vi) when the turn score can equal zero:
(1) selecting a multiplier;
(2) removing a fourth block from its space in the stack, the removed fourth block having, before removal, at least two exposed faces and at least a fifth block above it in the stack, the removal of the fourth block allowing the fifth block to move into a space formerly occupied by the removed fourth block;
(3) determining third and fourth scoring values, the fourth scoring value being based on a value indicated on a face of the fifth block and either the base value or a value indicated on a face of the sixth block, whichever the fifth block rests upon after it has moved;
(4) selecting a second mathematical operation to use with the third and fourth scoring values; and
(5) re-determining the turn score based on the third and fourth scoring values, the second mathematical operation, and the selected multiplier.

11. The method of claim 10, wherein each of the mathematical operation and the second mathematical operation is selected from a set including addition, subtraction, and multiplication.

12. The method of claim 8, wherein scoring the game comprises determining a winner from among the one or more players, wherein the winner is based on a highest total of turn scores.

13. The method of claim 7, wherein the turn further comprises moving one block from a receptacle in the base to one of the successive layer on top of at least one other block.

14. The method of claim 13, wherein the at least one other block is adjacent to the receptacle of the base from which the one block has been moved.

15. The method of claim 8, wherein determining the first and second scoring values comprises determining a second value of a face of the second block and a third value of a face of the third block.

16. The method of claim 15, wherein the second value is the value of the face of the second block adjacent to the third block, and the third value is the value of the face of the third block adjacent to the second block.
